(19) United States
(12) Patent Application Publication
(10) Pub. No.: US 2022/0132743 A1
(43) Pub. Date: May 5, 2022

(54) Garden Shears with Tongs

(71) Applicant: John Charles Newbury, Neath (GB)

(72) Inventor: John Charles Newbury, Neath (GB)

(21) Appl. No.: 17/083,346

(22) Filed: Oct. 29, 2020

(51) Int. Cl. A01G 3/02; B25G 1/10

(52) U.S. Cl. CPC A01G 3/02; A01G 2003/023; B25G 1/102

(57) ABSTRACT

The present invention allows an individual to pick up lawn and garden clippings without risking injury to the hand area from sharp objects. The device prevents back strain from continually bending and straightening to pick up lawn and garden clippings. It reduces the number of unnecessary trips to dispose of clippings. The present invention provides for an easier experience by allowing an individual to collect and pick-up all clippings at one time.

### BACKGROUND OF PROBLEM

The conventional gardening shears is a handy tool for trimming but is limited in design. Once trimming is completed, an individual must collect all trimmings by hand and dispose. Even though gardening gloves may be worn, an individual is still at risk of puncturing the glove area if collecting thorny or prickly gardening debris. The most time consuming aspect of gardening, and one which requires the greatest effort from the gardener is collection of the clippings and debris. Several trimming attempts are often called for, resulting in multiples trips to discard, and that the conventional gardening shears is inefficient at best. A suitable solution is desired.

### SOLUTION

The present invention allows an individual to pick-up lawn and garden clippings without risking injury to the hand area from sharp objects. The device prevents back strain from continually bending and straightening to pick up lawn and garden clippings. It reduces the number of unnecessary trips to dispose of clippings. The present invention provides for an easier experience by allowing an individual to collect and pick up all clippings at one time.

### DETAILED DESCRIPTION OF INVENTION

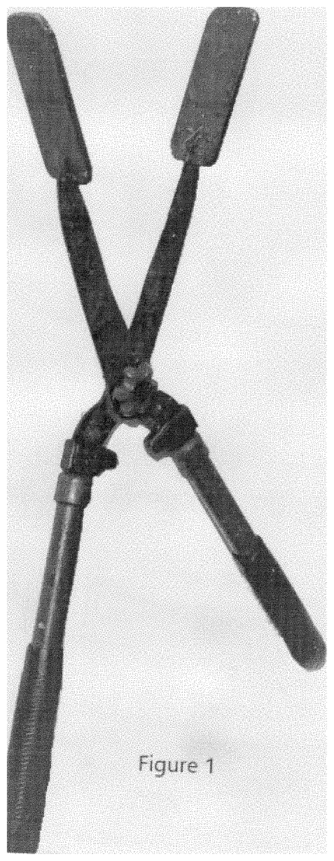

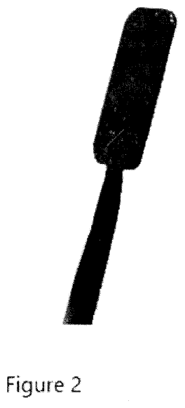

Referring to FIGS. 1-2 Garden Shears with Tongs consist of sharpened, cast iron or steel blades secured in the centre by an iron bolt to enable opening and closing of the shears. At the end of the shears are metal paddles, welded to the ends. The handles could be either ribbed plastic or rubber to enable secure grip. The tong-like members may be used for picking up debris after gardening and putting the debris in a bucket or wheelbarrow for discarding.

Exact measurements and specifications may vary.

Detailed description of drawings attached.

FIGS. 1 and 2 shows the device components.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilise the present invention and various embodiments with various modifications as are suited to the particular use contemplated.

What is claimed:

1. Garden Shears with Tongs consisting of:
sharpened, cast iron or steel blades secured by an iron bolt to enable opening and closing of the shears; metal paddles, welded at one end; handles comprising either ribbed plastic or rubber to enable secure grip, attached at an opposite end; and wherein the metal paddles are designed for picking up debris after gardening and putting the debris in a bucket or wheelbarrow for discarding.
